(19) United States
(12) Patent Application Publication
(10) Pub. No.: US 2006/0111813 A1
(43) Pub. Date: May 25, 2006

(54) Automated manufacturing system

(75) Inventor: Noritaka Nishiyama, Anjo-shi (JP)

Correspondence Address: HARNESS, DICKEY & PIERCE, P.L.C., P.O. BOX 828, BLOOMFIELD HILLS, MI, 48303, US

(73) Assignee: DENSO Wave Incorporated, Tokyo (JP)

(21) Appl. No.: 11/287,061

(22) Filed: Nov. 23, 2005

(30) Foreign Application Priority Data
Nov. 25, 2004 (JP) 2004-340448

(51) Int. Cl. G06F 19/00

(52) U.S. Cl. 700/253; 700/245

(57) ABSTRACT

The manufacturing system includes an industrial robot, a plurality of work devices, a plurality of unit frames, each of the work devices being mounted on a corresponding one of the unit frames, and a data storage storing a robot control program describing operations of the industrial robot with the work devices. Each of the operations is described using at least one reference point marked on a corresponding one of the unit frames as a reference position. The unit frames are configured detachable to a base frame on which the industrial robot is mounted.

### CROSS-REFERENCE TO RELATED APPLICATION

This application is related to Japanese Patent Application No. 2004-340448 filed on Nov. 25, 2004, the contents of which are hereby incorporated by reference.

### BACKGROUND OF THE INVENTION

1. Field of the Invention

The present invention relates to an automated manufacturing system constituted by a plurality of work devices and at least one industrial robot.

2. Description of Related Art

In recent years, there is tendency that the life cycles of manufactured products are becoming shorter and shorter. Accordingly, automated manufacturing systems are required to have flexibility to be usable for manufacturing a variety of products and to have short set up times.

Conventionally, as shown in FIG. 12, such an automated manufacturing system is assembled by mounting, on a common frame 1, a robot 2, and necessary work devices such as a conveyor 3, and a parts feeding device 4. The frame 1 is designed to have a specific shape and a size matching a specific production line. Accordingly, the frame 1 cannot be diverted for other production lines, and has to be scrapped when it becomes unnecessary. This increases production costs. Furthermore, in assembling the automated manufacturing system, since power wires, air pipes, signal wires, etc. are laid on site only after all the work devices are fixed to the frame, it is difficult to reduce man-hour costs for wire and pipe installation. Also, since programs for controlling the operation of the automated manufacturing system start to be developed after the specification of the automated manufacturing system is determined, it is difficult to improve the program development efficiency.

Japanese Patent Application Laid-open No. 6-214632 discloses configuring a robot device and a stocker device as independent modules, and installing a plurality of the stocker modules on a frame on which the robot module is mounted for the purpose of improving the assembling efficiency, wiring efficiency and program development efficiency of the automated manufacturing system by means of moduralization of the robot device and stocker device, and standardization of the assembling works. However, the automated manufacturing system provided by the above patent document has a problem in that the size and shape of the common frame (robot frame) place strong constraint on the maximum mountable number and sizes of the modules. If the common frame is made large, the administrative and maintenance expense as well as the production cost thereof increase, because the large frame occupies a large area in a factory.

Furthermore, since the control program controlling the operation of the robot module is developed only after the positional relationships between the robot module and other modules are clearly determined, and also the robot module has to be taught the position of each module after the control program is developed, there is another problem in that it is necessary to allow for a long period of time to perform the setup of the automated manufacturing system each time it is assembled.

### SUMMARY OF THE INVENTION

The invention provides an automated manufacturing system including:

an industrial robot;

a plurality of work devices;

a plurality of unit frames, each of the work devices being mounted on a corresponding one of the unit frames; and

a data storage storing a robot control program describing operations of the industrial robot with the work devices, each of the operations being described using at least one reference point marked on a corresponding one of the unit frames as a reference position;

the unit frames being configured detachable to a base frame on which the industrial robot is mounted.

The automated manufacturing system of the invention has flexibility in configuration, because it can be assembled by joining together pooled work modules each of which is constituted by a work device mounted on its unit frame, and an industrial robot mounted on its base frame. In addition, since the robot control program is described for each of the unit modules using their local work coordinate systems, and stored in different files in the sever or data storage, the robot can operate with all the unit modules on the basis of the programs described in the files if the positions of the unit frames are provided. Accordingly, with this invention, the setup time of the assembled automated manufacturing system can be shortened greatly.

### BRIEF DESCRIPTION OF THE DRAWINGS

In the accompanying drawings:

FIG. 1 is a diagram explaining how an automated manufacturing system according to a first embodiment of the invention is assembled;

FIG. 2 is a diagram showing a configuration of an example of the automated manufacturing system according to the first embodiment of the invention;

FIG. 3 is a diagram schematically showing-mainly in terms of software a configuration of a controller of the automated manufacturing system according to the first embodiment of the invention;

FIGS. 4 and 5 are diagrams showing a mechanical configuration of an example of the automated manufacturing system according to the first embodiment of the invention;

FIG. 6 is a flowchart showing the procedure for assembling the automated manufacturing system according to the first embodiment of the invention;

FIG. 7 is a diagram illustrating the procedure for assembling the automated manufacturing system according to the first embodiment of the invention;

FIG. 8 is a diagram showing a configuration of an example of an automated manufacturing system according to a second embodiment of the invention;

FIG. 9 is a diagram explaining a configuration of a robot of an automated manufacturing system according to a third embodiment of the invention;

FIG. 10 is a flowchart explaining the procedure of a robot teaching operation in the automated manufacturing system according to the third embodiment of the invention;

FIG. 11 is a diagram explaining the relationship between a local work coordinate system and a robot coordinate system in the automated manufacturing system according to the third embodiment of the invention; and

FIG. 12 is an appearance view of a conventional automated manufacturing system.

### PREFERRED EMBODIMENTS OF THE INVENTION

### First Embodiment

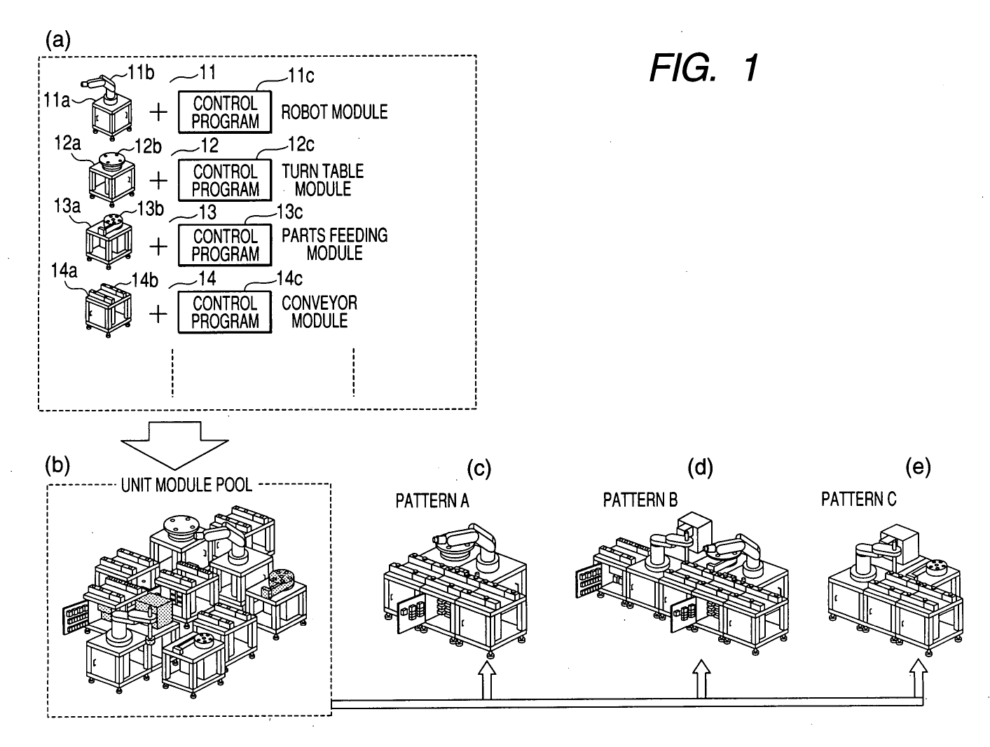

FIG. 1 is a diagram explaining how an automated manufacturing system of the invention is assembled. As shown in (a) in FIG. 1, work devices performing their specific functions and an industrial robot are mounted on their respective unit frames. One work device (or industrial robot) mounted on its unit frame and its control program (control software) constitute one unit module (a robot module 11, a turn table module 12, a parts feeding module 13, a conveyor module 14, etc.).

For example, the robot module 11 is constituted by a unit frame 11a, an industrial robot 11b mounted on the unit frame 11a, and a robot control program 11c for the control of the operation of the robot 11b. The turn table module 12 is constituted by a unit frame 12a, a turn table device 12b mounted on the unit frame 12a, and a turn table control program 12c for the control of the operation of the turn table device 12b. The parts feeding module 13 is constituted by a unit frame 13a, a parts feeding device 13b mounted on the unit frame 13a, and a parts feeding control program 13c for the control of the operation of the parts feeding device 13b. The conveyor module 14 is constituted by a unit frame 14a, a work transfer device 14b mounted on the unit frame 14a, and a work transfer control program 14c for the control of the operation of the work transfer device 14b. By combining necessary ones of the pooled unit modules (see (b) in FIG. 1), various patterns (pattern A, pattern B, pattern C shown in (c), (d), (e) in FIG. 1) of the automated manufacturing system can be obtained. Each of these patterns includes at least one robot module.

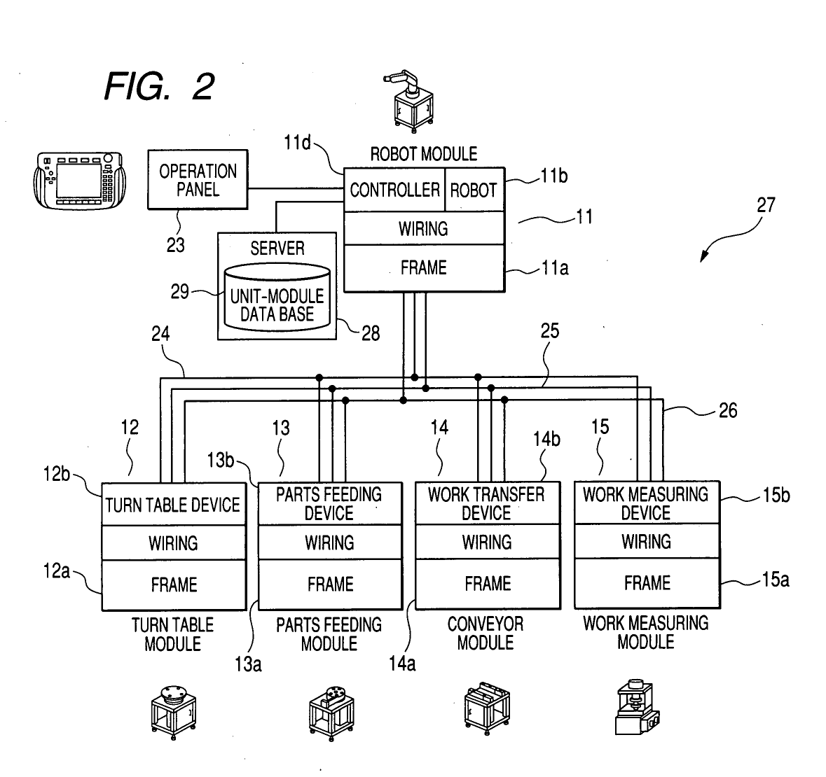

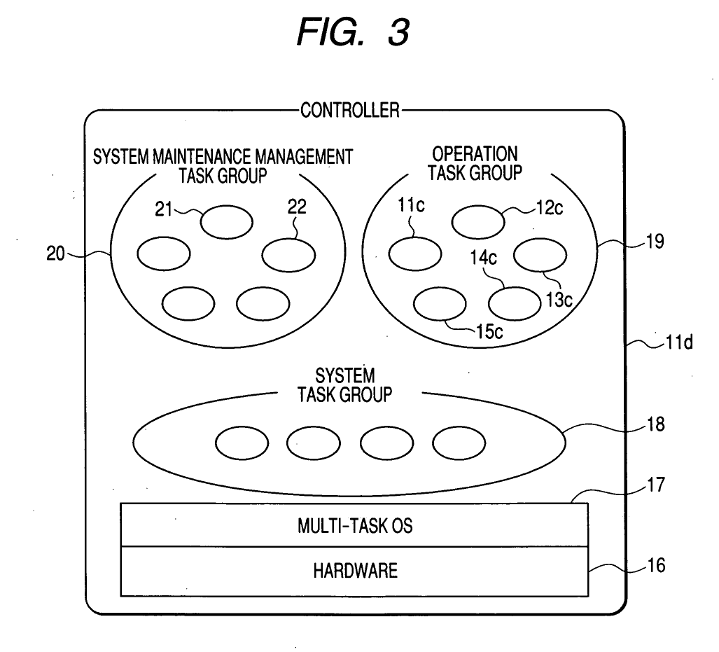

FIG. 2 is a diagram showing a configuration of an example of the automated manufacturing system of the invention. This example includes, as the unit modules, a robot module 11, a turn table module 12, a parts feeding module 13, a conveyor module 14, and a work measuring module 15. The work measuring module 15 is constituted by a unit frame 15a, a work measuring device 15b, and a work measurement control program 15c (see FIG. 3) for the control of the work measuring device 15b.

In this example, the robot module is provided with a controller 11d. FIG. 3 schematically shows a configuration of the controller 11d mainly in terms of software. The controller 11d has a hardware 16 including a CPU, a hard disk, an I/O, etc., a multi-task OS 17, a system task group 18, an operation task group 19, and a system maintenance management task group 20. The multi-task OS 17 manages the resource of the controller 11d in order to mediate between user programs and the hardware 16.

The system task group 18 includes tasks operating on the multi-task OS 17 to execute basic controls (communication control between a man-machine interface of the controller 11d and external devices) commonly needed for running user programs to actuate various devices.

The operation task group 19 and the system maintenance management task group 20 both including tasks prepared as user programs by the user of the automated manufacturing system are installed in a storage such as a hard disk of the controller 11d. These user programs are run on the multi-task OS 17 and the system task group 18 by the CPU of the hardware 16.

The operation task group 19 includes device-dedicated operation tasks such as the robot control task (robot control program) 11c, turn table control task (turn table control program) 12c, parts feeding task (parts feed control program) 13c, work-transfer task (work transfer control program) 14c, and work measurement task (work measurement control program) 15c.

The system maintenance management task group 20 includes a system monitoring task 21, and a system global control task 22. The system monitoring task 21 is for monitoring the operation states of the robot and work devices 11b to 15b by performing pattern recognition on image signals sent from a camera (not shown) and by referring to sensor signals sent from various sensors (not shown). When the system monitoring task 21 detects a person approaching the system, or detects a possibility of the system being damaged, the system global control task 22 operates to shift the production line to a safe side. For example, the operation of the production line is stopped at least in part, or operation speed is lowered.

Referring back to FIG. 2, an operation panel (teaching pendant) 23 serving as a man-machine I/F is connected to the controller 11d. This operational panel makes it possible to display necessary information therein, and also for the user to input operational commands to the system. After the unit frames 11a to 15a of the unit modules 11 to 15 are jointed together, the unit modules 11 to 15 are connected to one another by a power cable 24, a communication cable 25, an air pipe 26, etc. A server 28 is also connected as a data storage to the controller 11d through a communication network. The server 28 stores unit-module data base 29 containing unit module numbers for identifying the unit modules 11 to 15, robot teaching data, a robot control program 11c, device control programs 12c to 15c, etc.

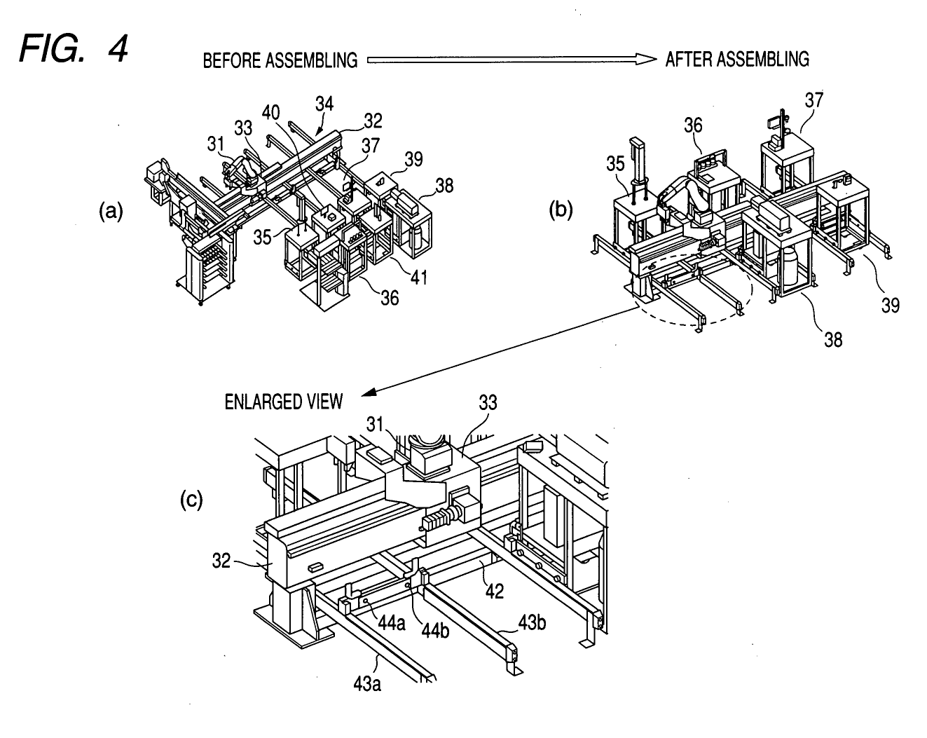

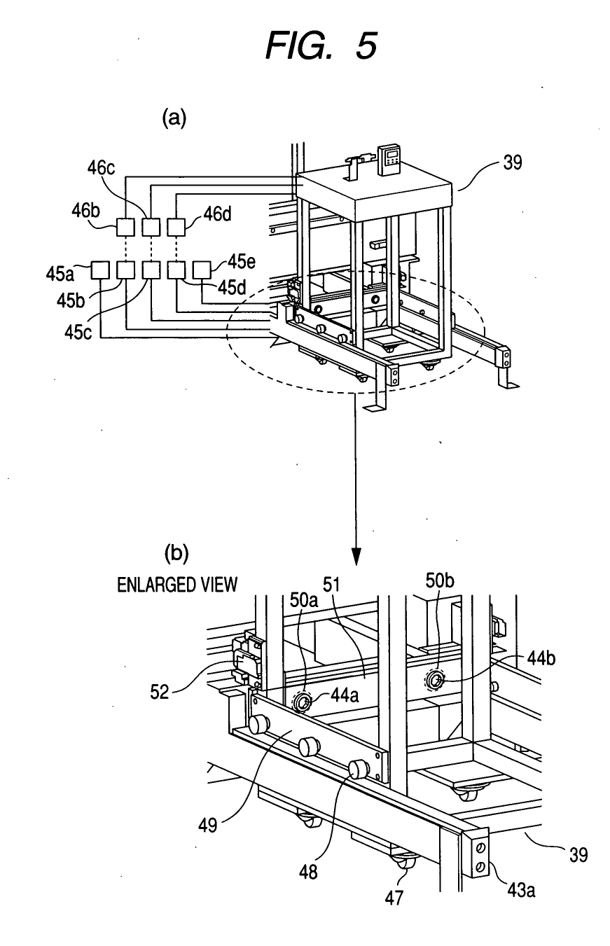

FIGS. 4 and 5 show an example of mechanical configuration of the automated manufacturing system of the invention. As shown in (a) in FIG. 4, in this example, an industrial robot 31 is mounted on a unit frame 33 which is movable along a linear traveling track 32. The unit frame 33 and the linear traveling track 32 constitute a base frame 34. The reference numerals 35 to 41 denote other unit frames. In this example, as shown in (b) in FIG. 4, the unit frames 35 to 39 are selected and detachably joined to the base frame 34.

The part circled by a dashed line in (b) in FIG. 4 is enlarged in (c) in FIG. 4. The base frame 34 has a beam 42 extending in parallel with the traveling track 32 under the traveling track 32, and several pairs of two guide rails 43a, 43b extending orthogonally to the beam 42. The guide rails 43a, 43b are for guiding the unit frame to a joint position with the base frame 34. The beam 42 is provided with several pairs of locating pins 44a, 44b for securing the unit frame at the joint position to the beam 42.

FIG. 5 shows the unit frame 39 joined to the base frame 34. As shown in (a) in FIG. 5, the base frame 34 is provided with several sets of coupling connectors 45a to 45e, and the unit frame 39 is provided with coupling connectors 46b to 46d. When the unit fame 39 is joined to the base frame 34, the coupling connectors 46b to 46d are plugged into corresponding ones of the coupling connectors 45a to 45e. The part circled by a dashed line in (a) in FIG. 5 is enlarged in (b) in FIG. 5. The unit frame 39 has traveling wheels 47 at its bottom end, and rollers 48 fitted to a support plate 49 at right and left sides of the unit frame 39.

The unit frame 39 further has an abutment plate 51 abutting against the beam 42 of the base frame 34. The abutment plate 51 has through holes 50a, 50b formed therein for receiving the locating pins 44a, 44b to fix the unit frame 39 to the base frame 34. By fastening metal fittings 52 provided in the base frame 34 to the unit frame 39, they are locked to each other.

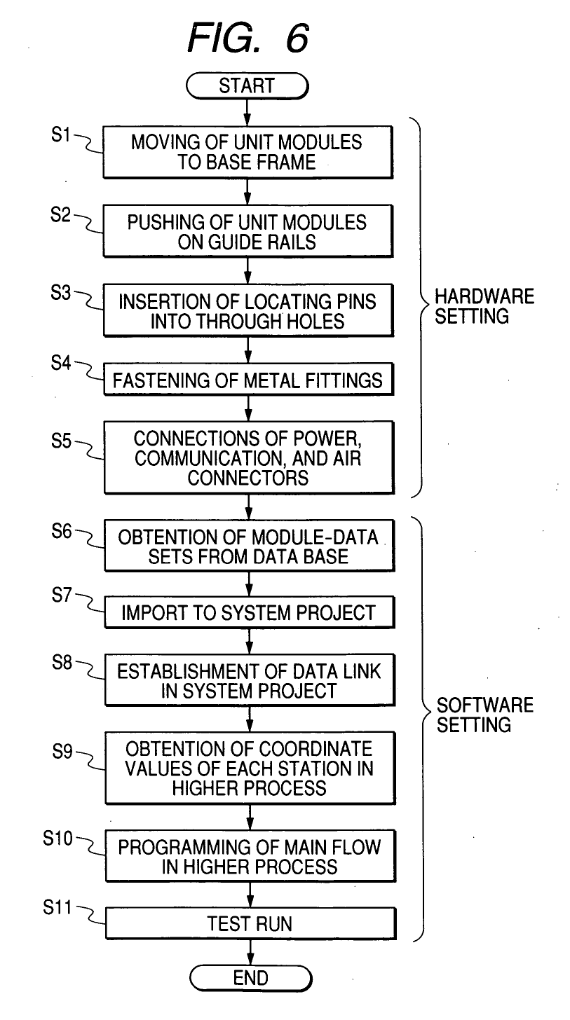

Next, the procedure for assembling the automated manufacturing system described above is explained below with reference to the flowchart of FIG. 6.

First, the unit frames on which unit modules required of the system are mounted are moved near the base frame (step S1). Each of the unit frames is put on the guide rails and pushed towards the traveling track of the base frame (step S2). The locating pins on the base frame side are inserted into the through holes on the unit frame side (step S3). The metal fittings provided in the base frame are fastened to the unit frame (step S4). The connectors of the power cable, communication cable and air pipe on the unit frame side are plugged into the corresponding connectors on the base frame side (step S5) to complete the hardware setting.

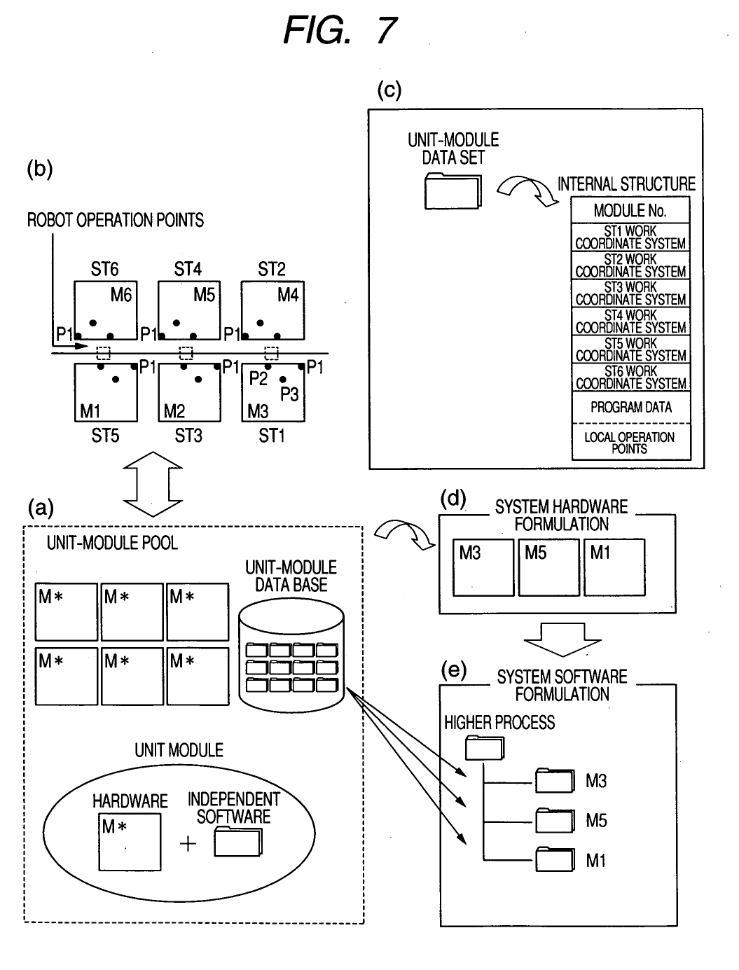

The processes of step S1 to step S5 are illustrated in (a) and (b) in FIG. 7. In this illustration, it is assumed that unit modules M1 to M6 are selected from a unit module pool, and located at stations ST1 to ST6 in the base frame.

The internal structure of a unit-module data set related to one of the unit modules (referred to as “unit module in question” hereinafter), which is contained in the unit-module data base 29, is shown in (c) in FIG. 7. In each of “ST1 work coordinate system” to “ST6 work coordinate system”, coordinate values of three reference points P1 to P3 which the robot has been taught are written for the purpose of allowing the unit module in question to be located at any one of the stations ST1 to ST6.

The “program data” in this unit-module data set includes one of the device control programs 12c to 15c described using the local work coordinate systems defined for the unit frames 12a to 15a, respectively. The “program data” further includes one of files constituting the robot control program 11c, which is described using the local work coordinate system defined for the unit module in question used for controlling the operation of the robot 11b with the unit module in question.

After the hardware setting is completed, software setting is carried out. Returning back to the flowchart of FIG. 6, the controller 11d reads, from the unit-module data base 29, unit-module data sets related to the unit modules having the unit module numbers which the user has designated by use of the operational panel 23 (step S6), and the read unit-module data sets are imported to a system project (step S7). Subsequently, a data link is established within the system project (step S8) The processes of the step S1 to step S8 correspond to (a) (d) (e) in FIG. 7. For example, when the unit modules M1, M3, M5 are designated, the unit-module data sets related to the unit modules M1, M3, M5 are subordinated to a “higher process”. The “higher process”, which corresponds to the system global control task 22 included in the system maintenance management task group 20, is a program describing overall control of the system.

Next, the higher process obtains, from the unit module data base, the coordinate values representing the positions of the unit modules, which depend on at which stations they are located (step S9). Obtaining these coordinate values enables combining the different local work coordinate systems defined for the different unit modules into the robot coordinate system defined for the robot module. After that, a main flow specifying the starting sequence of the programs described in the files constituting the robot control program 11c is programmed (step S10). Finally, a test run is executed to check the operation of the system.

As explained above, the automated manufacturing system of this embodiment is assembled by joining together the pooled work devices 12b to 15b mounted on the unit frames 12a to 15a and industrial robot 11b mounted on the unit frame 11a. Accordingly, the automated manufacturing system of this embodiment has flexibility in configuration. In addition, since the robot control program 11c is described for each of the unit modules 12 to 15 using their local work coordinate systems, and stored in different files in the sever 28, the robot 11b can operate with all the unit modules 12 to 15 on the basis of the programs described in the files only if the positions of the unit frames 12a to 15a are provided. Accordingly, with this embodiment, the setup time of the assembled automated manufacturing system can be shortened greatly.

Furthermore, since the unit frames 35 to 39 are made jointable to the base frame 34 on which the robot 11b is mounted by means of the locating pins 44a, 44b, through holes 50a, 50b, guide rails 43a, 43b, rollers 48, etc, the assemble work of the automated manufacturing system becomes very easy.

Furthermore, since the unit frames have a predetermined size, the overall size of the automated manufacturing system can be estimated easily from its specification.

### Second Embodiment

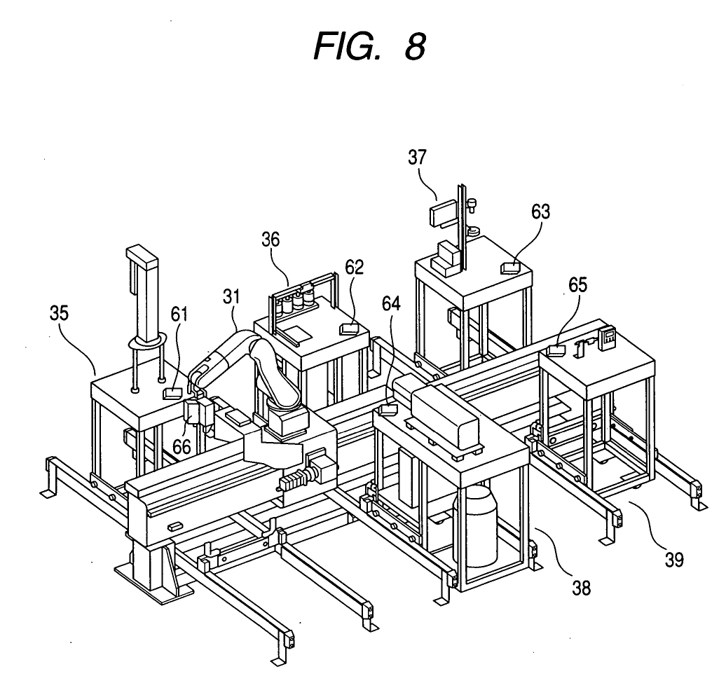

FIG. 8 shows an example of an automated manufacturing system according to a second embodiment of the invention. In the second embodiment, the elements that are the same as those in the first embodiment are given the same reference numerals, and explanation thereof is omitted.

In the second embodiment, the unit frames 35 to 39 are provided with RFID tags 61 to 65, and the robot 31 mounted on the base frame 34 is provided with a tag reader 66 at the front end of its arm. The RFID tags 61 to 65 serving as a memory device, respectively, constitute a data storage. Although the unit-module data sets are stored altogether in the unit-module data base 29 in the first embodiment, in the second embodiment, they are stored separately in the RFID tags 61 to 65. The unit-module data sets read by the tag reader 66 via radio waves are serially transferred to a not shown controller equivalent to the controller 11d mounted on the base frame 34.

In the second embodiment, instead of accessing the unit-module data base 29 at step S6 of the flowchart shown in FIG. 6, the robot is moved sequentially along the traveling track to read the unit-module data sets stored in the RFID tags 61 to 65 by the tag reader 66. Even when precise positions of the unit frames 35 to 39 are unknown before the robot is moved sequentially along the traveling track, it is possible to the ID tag reader 66 can read the unit-module data sets stored in the RFID tags 61 to 65 by the tag reader 66 if the positions of the unit frames 35 to 39 are roughly known, because the tag reader 66 uses radio signals.

In the second embodiment, since the hardware and software for controlling this hardware are provided altogether for each work device, the time needed for developing the software for overall control of the system can be shortened.

### Third Embodiment

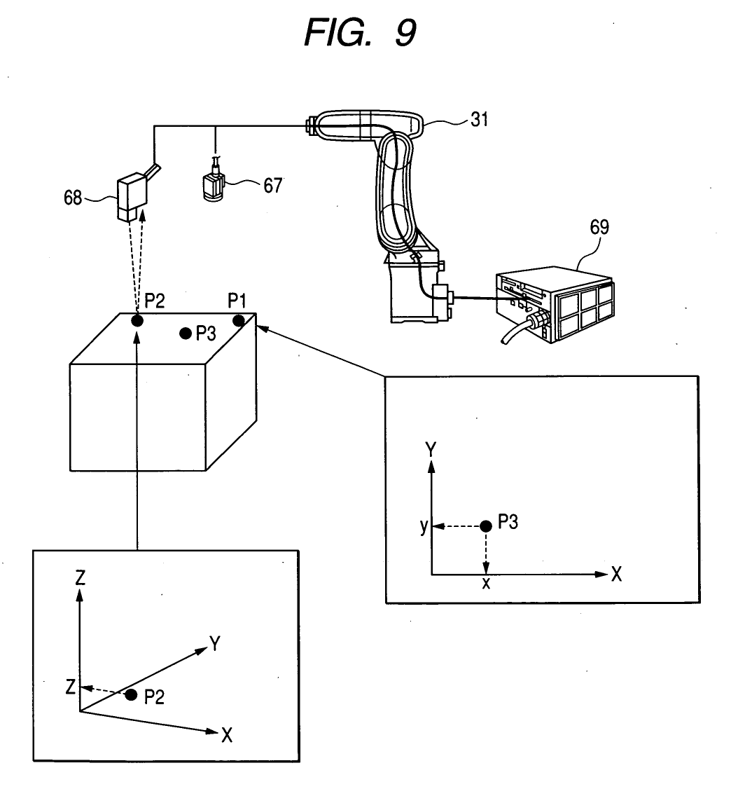

FIG. 9 is a diagram explaining a configuration of an example of an automated manufacturing system according to a third embodiment of the invention. As shown in this figure, in the third embodiment, the robot 31 is provided with a CCD camera 67 and a distance sensor 68 at the front end of its arm for the purpose of performing robot teaching operation efficiently.

In the first embodiment, the robot teaching operation is performed by bringing the front end of the robot arm into contact with the reference points P1, P2, P3 marked on the top surface of the unit frame. On the other hand, in the third embodiment, the robot teaching operation is performed by taking an image including the reference points P1, P2, P3 altogether by the CCD camera 67 to determine their two-dimensional positions, and measuring the distances to the reference points P1, P2, P3 by the distance sensor 68. The distance sensor 68 may be of the type to use the reflection of infrared ray. The data obtained by this robot teaching operation is serially transferred to a controller 69 as in the case of the second embodiment.

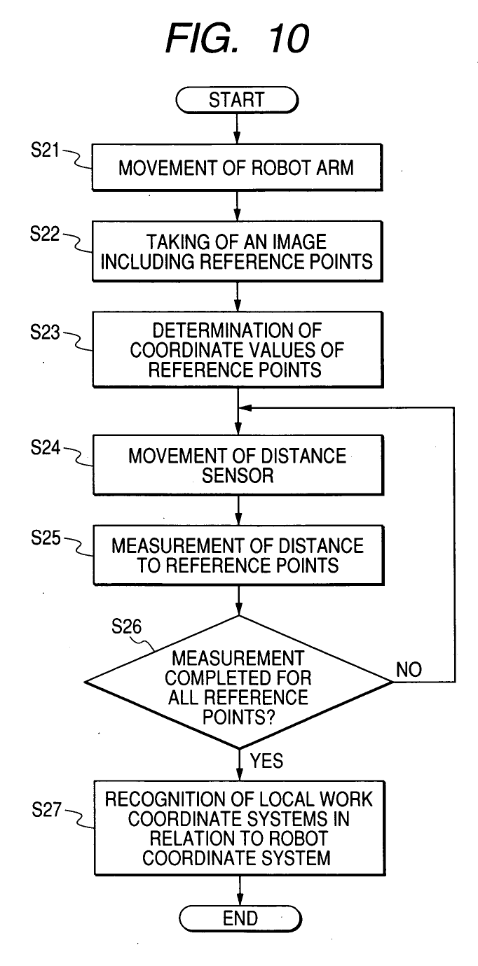

FIG. 10 is a flowchart explaining the process of the robot teaching operation (three-dimensional coordinates acquisition process). As show in this flowchart, the controller 69 moves the arm of the robot 31 to a position where the CCD camera 67 can take an image including the reference points P1, P2, P3 altogether (step S21), and at the subsequent step S22, the CCD camera 67 takes such an image. Next, the controller 69 obtains the two-dimensional coordinate values (x, y) of each of the reference points P1 to P3 in each of the local work coordinate system and the robot coordinate system by performing pattern recognition on the image taken by the CCD camera 67 (step S23). In this embodiment, the reference point 1 is an origin point of the local work coordinate system, and the reference point P2 is a point on the X axis of the local work coordinate system.

Next, the controller 69 moves the robot arm to the position having two-dimensional coordinate values equal to those of the reference point P1 (step S24), and measures the vertical distance to the reference point P1 by use of the distance sensor 68 (step S25). From the measured distance, the z-coordinate value of the reference point P1 in each of the local work coordinate system and the robot coordinated system can be obtained. This vertical distance measuring procedure is performed also for the reference points P2, P3. When this vertical distance measuring procedure is completed for all the reference points P1 to P3 (step S26), the local work coordinate system can be recognized in relation to the robot coordinate system.

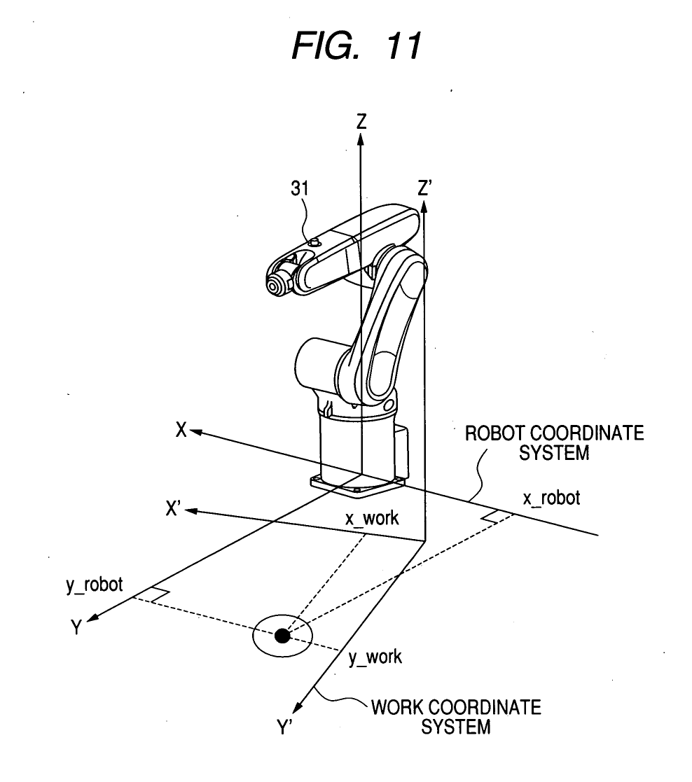

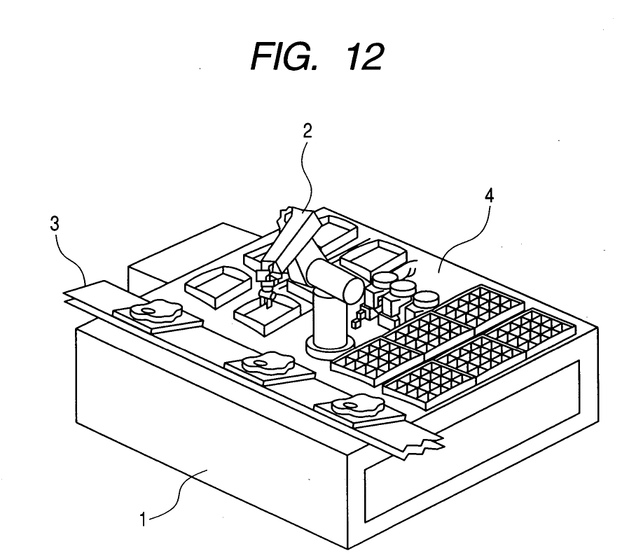

FIG. 11 is a diagram explaining the relationship between the local work coordinate system X′ Y′ Z′ and the robot coordinate system XYZ. The local work coordinate system may not be parallel to the robot coordinate system, but inclined to the robot coordinate system depending on the joining state of the unit frame. In this embodiment, the inclination of the local work coordinate system can be compensated for on the basis of the three-dimensional coordinate values of the reference points P1 to P3.

In the third embodiment, the robot teaching operation can be omitted, because it is possible to have the robot recognize the local work coordinate system in relation to the robot coordinate system by taking the image including the reference points marked on the top surface of the unit frame and measuring the vertical distances to the reference points.

Although the controller for the overall control of the system is disposed on the base frame side in the above described embodiments, each unit module may have its dedicated controller. The unit frame may be marked with two reference points, or only one reference point if the inclination of the local work coordinate system with respect to the robot coordinate system is negligible.

The above explained preferred embodiments are exemplary of the invention of the present application which is described solely by the claims appended below. It should be understood that modifications of the preferred embodiments may be made as would occur to one of skill in the art.

What is claimed is:

1. An automated manufacturing system comprising:
an industrial robot;
a plurality of work devices;
a plurality of unit frames, each of said work devices being mounted on a corresponding one of said unit frames; and
a data storage storing a robot control program describing operations of said industrial robot with said work devices, each of said operations being described using at least one reference point marked on a corresponding one of said unit frames as a reference position;
said unit frames being configured detachable to a base frame on which said industrial robot is mounted.

2. The automated manufacturing system according to claim 1, further comprising a plurality of positioning members positioning said unit frames when said unit frames are joined to said base frame.

3. The automated manufacturing system according to claim 2, wherein said positioning members are configured to guide said unit frames to predetermined joint positions when said unit frames are joined to said base frame.

4. The automated manufacturing system according to claim 3, wherein said positioning members include a plurality of pairs of guide rails provided in said base frame, and rollers provided in each of said unit frames so as to be able to run on one of said plurality of said pairs of said guide rails.

5. The automated manufacturing system according to claim 1, wherein said data storage includes a memory device provided in each of said unit frames, said memory device storing a part of said robot control program describing operation of said robot with one of said work devices, and industrial robot is provided with a reading device capable of reading said memory device.

6. The automated manufacturing system according to claim 5, wherein said memory device is an RFID tag, and said reading device is an RFID tag reader.

7. The automated manufacturing system according to claim 5, wherein said memory device further stores data representing position of said at least one reference point as robot teaching data.

8. The automated manufacturing system according to claim 5, wherein said memory device further stores a device control program for control of one of said work devices, and said base frame is provided with a controller controlling each of said work devices on the base of said device control program read from said memory device by said reading device.

9. The automated manufacturing system according to claim 5, further comprising a controller for overall control of said automated manufacturing system, an imaging device for taking an image including said at least one reference point for each of said unit frames, and a distance sensor for detecting a distance to said at least one reference point for each of said unit frames, said controller being configured to recognize local coordinate systems defined for said unit frames, respectively, in relation to a robot coordinate system defined for said base frame on the basis of three-dimensional coordinate values of said at least one reference point in each of said local coordinate systems and said robot coordinate system obtained on the basis of said image taken by said imaging device and said distance detected by said distance sensor.

10. The automated manufacturing system according to claim 9, wherein said imaging device is a camera provided in a front end of an arm of said industrial robot.

11. The automated manufacturing system according to claim 9, wherein said distance sensor is an infrared type sensor provided in a front end of an arm of said industrial robot.

12. The automated manufacturing system according to claim 1, wherein each of said unit frames is marked with three reference points.
